(19) United States
(12) Patent Application Publication
(10) Pub. No.: US 2008/0111410 A1
(43) Pub. Date: May 15, 2008

(54) Safety Device for Infant Chairs Being Applicable to Vehicles

(76) Inventor: Manuel Jane Santamaria, Palau de Plegamans (ES)

Correspondence Address: JORDAN AND HAMBURG LLP, 122 EAST 42ND STREET, SUITE 4000, NEW YORK, NY, 10168, US

(21) Appl. No.: 11/665,773

(22) PCT Filed: Sep. 28, 2005
(86) PCT No.: PCT/ES05/00522

§ 371 Date: Apr. 17, 2007

(30) Foreign Application Priority Data
Nov. 25, 2004 (ES) U200402694

(51) Int. Cl. B60N 2/26; B60N 2/42

(52) U.S. Cl. 297/253; 297/467

(57) ABSTRACT

A safety device for a child seat for a vehicle has a harness including two adjustable straps being linked through a buckle to a crotch strap and has tensioning means for the tensioning of the two adjustable straps.

The lower ends of the straps extend through the child seat and are joined together underneath the child seat thereby forming a strap that passes through a tension device and extends beyond the front portion of the seat of the child seat, before being joined together the lower ends of the two adjustable straps passing through an assembly of guiding elements. The adjustment of the two adjustable straps is carried out with anchoring means being provided on the rear surface of the backrest of the child seat.

### BACKGROUND OF THE INVENTION

Different models of child seats for automobiles are already known, said infant chairs in order to securely fasten the child to the seat comprising a harness formed by two adjustable straps being linked through a buckle to a crotch strip, said straps being joined to each other at the rear portion of the backrest and thereby forming a length passing through a tension device and extending beyond the front portion of the seat of the child seat.

### SUMMARY OF THE INVENTION

It is the object of this invention to improve these safety devices by limiting the relative elasticity being displayed by the straps so that they are hence in a position to better hold back the child on the child seat in case of a collision.

In order to achieve this limitation of the elasticity the total length of the straps has been reduced, it having been for such a purpose foreseen to carry out their tensioning at their lower ends being guidedly passed through the buckle and extending through the child seat to be thereupon joined together underneath this latter and thus form the strip that passes through the tension device and extends beyond the front portion of the seat of the child seat.

The lower ends of the straps are joined together by means of guiding elements being adapted to have them arranged in a mutually juxtaposed arrangement at a central length before their being joined together.

The adjustment of the straps is carried out with anchoring means being provided on the rear surface of the backrest of the child seat.

These and other features will be best made apparent by the following detailed description whose understanding will be made easier by the accompanying sheet of drawings showing a practical embodiment being cited only by way of example not limiting the scope of the present invention.

### BRIEF DESCRIPTION OF THE DRAWINGS

In the drawings:

FIGS. 1a and 1b diagrammatically depict in a sectional elevation a conventional safety device and the one being the object of the invention, respectively;

FIG. 2 frontally shows an infant chair being provided with the safety device in question; and

FIG. 3 illustrates in a perspective view a detail of the guiding means being adapted to bring the lower ends of the straps together.

### DETAILED DESCRIPTION OF THE INVENTION

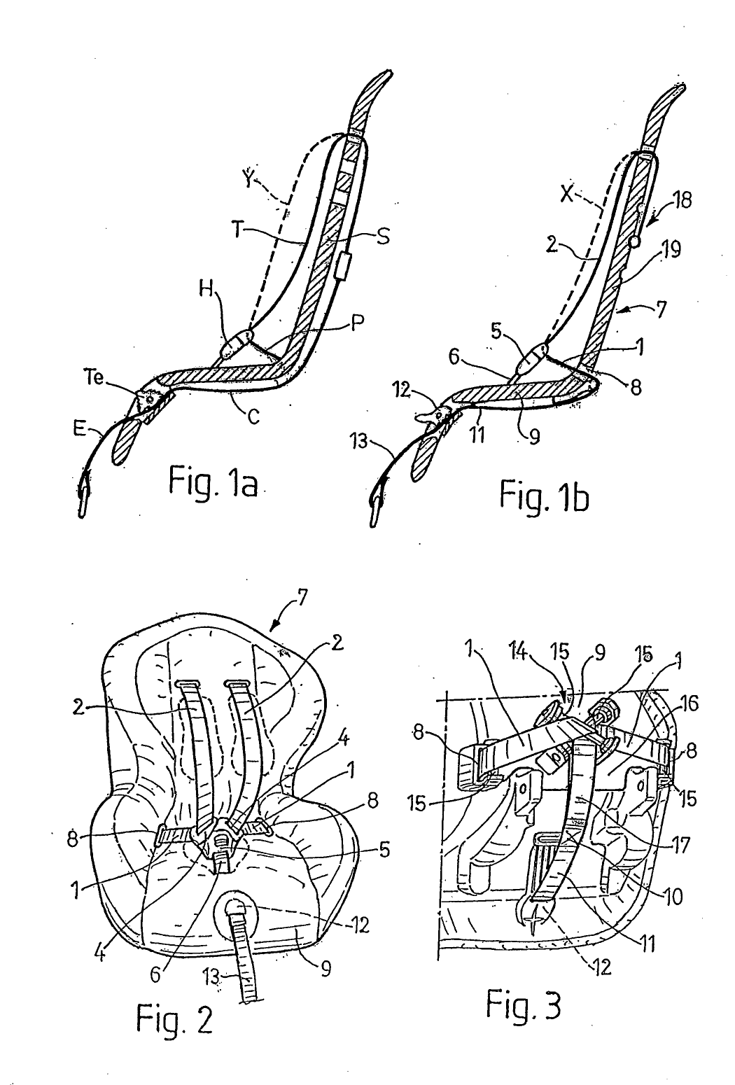

According to FIG. 1a the conventional devices have their straps (T) joined together at the rear and thus form a band (C) extending at the rear portion of the chair and thereupon passing through a tension device (Te), and the end (E) of the band extends beyond the front portion of the seat of the chair (S). At their lower end the straps (T) are fitted to a buckle (H) and are fixedly fastened at lateral points (P) of the seat of the child seat (S).

According to FIGS. 1b, 2 and 3 the safety device being the object of the invention is characterized in that the lower ends (1) of the straps (2), after having passed through slits (4) of the buckle (5) to which the crotch strip (6) is attached, extend through the child seat (7) through openings (8) being provided at the rear portion of the sides of the seat (9) of the child seat and are joined together at (10) underneath this latter thereby forming a strip (11) that passes through the tension device (12) and with its end (13) extends beyond the front portion of the seat (9) of the child seat.

Before being joined together the lower ends (1) of the two straps (2) pass through an assembly (14) of guiding elements, these latter being made up by rollers (15) being supported on a plate (16) being fixedly attached to the bottom of the seat (9), said rollers being adapted to guide said opposite ends (1) at a common, central length (17) being attached to the strip (11).

The adjustment of the straps (2) is carried out with anchoring means (18) being provided on the rear surface of the backrest (19) of the child seat.

Because of the shorter length of the straps (2) their extension (X) (FIG. 1b) being produced during a collision is reduced with respect to the extension (Y) (FIG. 1a) being produced in the straps (T) of the conventional safety devices, the child being thus held back in an improved manner.

The assembly (14) of the guiding means as well as the anchoring means (18) being provided at the rear ends of the straps for their adjustment can be carried out as per any other embodiments other than those having been depicted presently.

1. A safety device for a child seat for a vehicle, the child seat comprising a seat and a backrest, the safety device comprising a harness comprising two adjustable straps, the straps being linked through a buckle to a crotch strap, tensioning means for tensioning of the two adjustable straps, the lower ends of the straps being adapted to extend through the child seat and join together underneath the child seat, thereby forming a strap that passes through the tension device and extends beyond a front portion of the seat.

2. A safety device according to claim 1, further comprising an assembly of guiding elements, the lower ends of the two adjustable straps being adapted to pass through the assembly of guiding elements before joining together.

3. A safety device according to claim 2, wherein the guiding elements comprise rollers arranged in so as to bring opposite ends of the two adjustable straps together at a common, central length.

4. A safety device according to claim 1, further comprising anchoring means adapted to be situated on a rear surface of the backrest, the anchoring means being adapted to effect adjustment of the two adjustable straps.

5. A child seat for a vehicle provided with the safety device of claim 1.

6. A child seat for a vehicle provided with the safety device of claim 2.

7. A child seat for a vehicle provided with the safety device of claim 3.

8. A child seat for a vehicle provided with the safety device of claim 4.
